(19) United States
(12) Patent Application Publication
(10) Pub. No.: US 2020/0410617 A1
(43) Pub. Date: Dec. 31, 2020

(54) DYNAMIC AND AUTOMATIC AGREEMENT GENERATION AND MODIFICATION

(71) Applicant: ITERATE STUDIO, INC., Denver, CO (US)

(72) Inventors: Andrew A. Wichern, Denver, CO (US); Frederick Michael Frazzini, Aurora, CO (US)

(21) Appl. No.: 16/912,433

(22) Filed: Jun. 25, 2020

Related U.S. Application Data
(60) Provisional application No. 62/905,001, filed on Sep. 24, 2019.
(60) Provisional application No. 62/868,666, filed on Jun. 28, 2019.

(51) Int. Cl. G06Q 50/18; G06Q 10/10; G06Q 30/00; G06Q 50/26; G06Q 10/06; G06N 20/00; G06N 7/00

(52) U.S. Cl. CPC G06Q 50/188; G06Q 10/10; G06Q 30/0185; G06N 7/005; G06Q 10/0635; G06N 20/00; G06Q 50/265

(57) ABSTRACT

The present disclosure relates generally to systems and methods that can automatically generate agreements and provisions between two or more parties. In one example, the method includes receiving by a processing element a plurality of entity characteristics corresponding to at least one of the two or more parties, analyzing by the processing element two or more of the entity characteristics, utilizing by the processing element the analyzed two or more characteristics to identify a first agreement from two or more agreements, and outputting by the processing element the first agreement to a first user device corresponding to at least one of the two or more parties.

### CROSS REFERENCE TO RELATED APPLICATIONS

This application claims priority under 35 U.S.C. § 119 to U.S. provisional patent application No. 62/868,666 entitled “Dynamic and Automatic Agreement Generation and Modification,” filed on 28 Jun. 2019 and to U.S. provisional patent application No. 62/905,001 entitled “Dynamic and Automatic Agreement Generation and Modification,” filed on 24 Sep. 2019, both of which are incorporated by reference herein for all purposes.

### TECHNICAL FIELD

The technology described herein generally relates to agreement and contract generation, such as vendor, legal, and other commercial contracts.

### BACKGROUND

Many commercial contracts, vendor agreements, and other legal agreements between two or more parties are generated manually by an attorney or other knowledgeable person. This type of manual generation can be time consuming, imprecise, and expensive. Additionally, many times contracts require some negotiation or other discussion between the parties to select final terms, provisions, and other elements. Depending on the first draft of the agreement or other contract, often many rounds of revisions are required before the parties eventually have a document both sides will agree to and sign. This manual effort and negotiation time extends the time between when a contract is needed and when it is eventually executed, often correlating to business and opportunity losses. Further, such processes can become unworkable with many different vendors and parties and some businesses may forego agreements, introducing legal and business risk, to prevent such losses.

### SUMMARY

The present disclosure relates generally to systems and methods that can automatically generate agreements and provisions between two or more parties. In one example, the method includes receiving by a processing element a plurality of entity characteristics corresponding to at least one of the two or more parties, calculation by the processing element of two or more values of the entity characteristics, utilizing by the processing element a calculated score based on the values of two or more characteristics, and the weighting of each characteristic based on a statistical model of the influence of each characteristic on optimally generated agreements and provisions between two or more parties, to identify a first agreement from two or more agreements, and outputting by the processing element the first agreement to a first user device corresponding to at least one of the two or more parties.

In another embodiment, a method for generating an agreement is disclosed. The method includes receiving a plurality of entity characteristics corresponding to at least one of the two or more parties; analyzing two or more of the entity characteristics; utilizing the analyzed two or more characteristics to identify a first agreement from two or more agreements; and outputting the first agreement to a first user device corresponding to at least two or more of the parties.

In another embodiment, the disclosure includes a method to automatically incorporate feedback into agreement templates. The method includes receiving a plurality of executed agreements and contracting party characteristics corresponding to contracting parties for the executed agreements, comparing the plurality of executed agreements to a plurality of stored agreement templates, comparing the contracting party characteristics to stored entity characteristics assigned to the stored agreement templates, updating the stored agreement templates based on the comparison of the stored agreement templates and the contracting party characteristics.

In yet another embodiment, a method to generate an agreement is disclosed. The method includes classifying a plurality of entity characteristics corresponding to a first party to be bound by the agreement, based on the classification of the plurality of entity characteristics, generating one or more provisions for the agreement, and outputting to a user device associated with a first party the one or more provisions for the agreement.

In addition to the exemplary aspects and embodiments described above, further aspects and embodiments will become apparent by reference to the drawings and by study of the following description.

### BRIEF DESCRIPTION OF THE DRAWINGS

FIG. 1 illustrates a diagram of a system that can be used to automatically and dynamically generate agreements, legal documents, and provisions.

FIG. 2 is a simplified block diagram of many of the computing devices incorporated into the system.

FIG. 3 is a flow chart illustrating a method to receive entity information and use the information to generate agreements.

FIG. 4A is an example of a user interface to receive entity information.

FIG. 4B is another example of a user interface to receive entity information.

FIG. 5A is an example of a user interface to receive an agreement type selection.

FIG. 5B is an example of a user interface of agreement specific fields.

FIG. 6A is an example of a user interface for a host device illustrating multiple agreement and provision templates.

FIG. 6B is an example of a user interface displaying a provision selection or template.

FIG. 7 is a flow chart illustrating a method to determine question groupings to be displayed to a first party.

FIG. 8 illustrates a method to generate agreements and provisions for one or more entities.

FIG. 9A is an example of a valuation used for an entity characteristic.

FIG. 9B is an example of the valuation and agreement score ranges.

FIG. 10 is a flow chart illustrating a method to incorporate dynamic feedback to modify agreement generation.

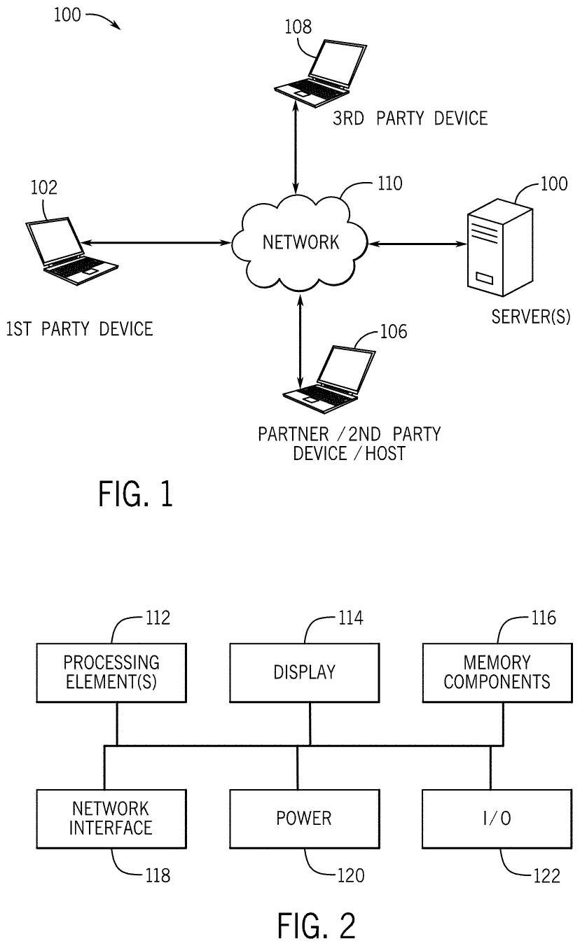

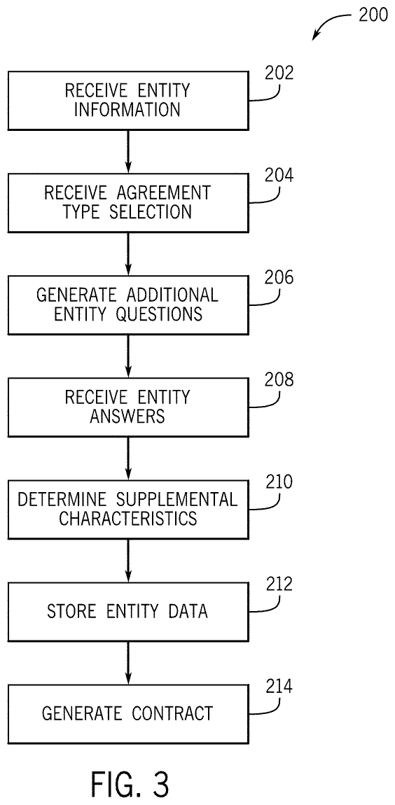

### DETAILED DESCRIPTION

The present disclosure includes a system and method for the dynamic and automatic generation of contracts, agreements, terms, and the like. In one embodiment, the system gathers information regarding one or more of the parties or contracting entities, such as form input from a user, automatically from third party sources (e.g., Internet, databases such as news websites, social media, and the like), from internal sources (e.g., past history with the entity, ecosystem and experience with related entities or similar entities, interaction on the platform, and the like), as well as feedback and tracking data, to generate provisions and/or contracts that are a fit for the one or more contracting parties. The automatic generation, along with dynamic feedback into the system, allows contracts, vendor agreements, and other documentation to be generated and agreed to with substantially no negotiation or back and forth between the parties, streamlining business and relationships.

As a specific example, a party that wants to enter into a contract with another party will enter information regarding the type of relationship or contract needed, select their own party characteristics (e.g., if the party is a company the operating time, revenue or raised funds, number of employees, market sector, location, customers), and deal characteristics (e.g., desired operating locations, restrictions, type of business relationship desired, etc.). The system then applies a scaled value to the deal characteristics in light of the party characteristics, party characteristic weighting, and contract type to generate a contract score. Utilizing the contract score and the other information, the system selects a contract, selected legal provisions, and/or contract terms (e.g., “builds” an agreement) and inputs the party information to generate the contract. The generated contract is then delivered to the party for review and execution.

In some instances, the party may request some changes to the contract or terms and the proposed changes can be analyzed to determine if acceptable or not. If the contract is revised, the updated contract is then redelivered to the party and if the contract is not revised a notification is sent to the party optionally with an explanation as to the reason the change was not entered. In either case, data regarding the proposed and accepted provisions, length of time from delivery to execution, and the like, is stored as feedback information and reapplied to the system, to assist the system in learning and making dynamic changes and modifications to both the inputs, values, weighting, and scoring done during the analysis. Other feedback input to the system includes marketplace trends, ecosystem information (e.g., information related to connected businesses, other entities, markets, and so on related to the entity), and other external information related to the business or field of the parties.

In some embodiments, the system may also utilize dynamic feedback to update the contract or other document being prepared. For example, the system may monitor the length of time that a user spends on one or more provisions (e.g., before receiving an input accepting a provision, time before scrolling down on the webpage or to the next provision, etc.) and uses that feedback to dynamically update further provisions or terms within the contract or document. In this manner, the party's engagement within the system during the generation operation may also be used to modify the contract or document.

In one specific implementation, the system is used to contractually bind multiple smaller parties (e.g., startup companies, early growth stage, pre revenue companies) with one or more large enterprise businesses (e.g., large companies, established businesses, and the like). In particular, the contractual terms generated are specific to the smaller company and are selected to be the anticipated “minimal legal protection” provisions that the company would be likely to agree to (i.e., likely amount of risk allocation shiftable onto the smaller company). The minimal threshold is based on the smaller company's characteristics, ensuring that the contracts will be likely to be approved within a large legal review or other context of the large enterprise and eliminating back and forth between the parties. In other words, the contract will be as “friendly,” or least risky in terms of risk allocation, to the large enterprise as possible, taking into account the likely expected push back and leverage by the smaller company. In other words, the provisions in the contract will include the minimum legal protections for the smaller company that the smaller company would be likely to agree to. For example, allocation of risk and reasonableness values can be quantified, such as via acceptance rates, historical application, standard vs. non-standard terms, and the like, that can then be used to determine type of ranking of a particular provision or agreement (i.e., as being fair or balanced lightly or heavily towards a particular party), with that information being used to select provisions and generate the contract.

Turning to the figures, a system 100 for dynamic generation of contracts will now be discussed. The system 100 includes one or more first party or entity devices 102, one or more second party or partner devices 104, one or more servers 106 or host devices, and/or one or more third party devices 108. The devices of the system 100 may be in communication with one another via a network 110. The network 110 may be any type of data transmission or communication mechanisms or multiple mechanism, such as, but not limited to, WiFi, Bluetooth, Zigbee, wired communications, stalactite, other types of radio wave, optical transmission methods, or the like.

The party or user devices 102, 104, 108 may generally correspond to the different parties, entities, and/or users looking to receive or execute business agreements, legal contracts, or the like, such as agreements between each other, vendors, or the like. In a specific implementation, the devices corresponding to the parties provide an input mechanism in which a party representative (e.g., users, employee, owner, counsel, etc.) uses to input information into the system 100 that may be stored and analyzed by the host device 106 or server 106. In this example, the host device 106 may receive and analyze the various data and information to generate the contracts. It should be noted that although only a single device is shown for the category of devices, there may be multiple devices corresponding to the various parties and/or resources, e.g., the server 106 may include multiple computing resources that may or may not be in communication with one another. Similarly, the respective parties may enter information to the system utilizing a variety of different types of devices.

The computing devices 102, 104, 108 may be substantially any type of electronic device that can receive and transmit data, such as, but not limited to, personal computer, laptop, smartphone, tablet, server, or the like. Similarly, the server 106 may be substantially any type of device that can receive and process information and may be a collection of one more virtual processing elements (e.g., cloud computing, virtual machines, and the like) that are in communication with another.

FIG. 2 illustrates a simplified block diagram for the various devices of the system. As shown, the various devices may include one or more processing elements 112, a display 114, one or more memory components 116, a network interface 118, and optionally power 120, where the various components may be in direct or indirect communication with one another, such as via one or more system busses, contract traces, wiring, or via wireless mechanisms.

The one or more processing elements 112 may be substantially any electronic device capable of processing, receiving, and/or transmitting instructions. For example, the processing elements 112 may be a microprocessor, microcomputer, graphics processing unit, or the like. It also should be noted that the processing elements 112 may include one or more processing elements or modules that may or may not be in communication with one another. For example, a first processing element may control a first set of components of the computing device and a second processing element may control a second set of components of the computing device where the first and second processing elements may or may not be in communication with each other. Relatedly, the processing elements may be configured to execute one or more instructions in parallel and across the network, such as through cloud computing resources.

The display 114 is optional and provides an input/output mechanism for the computing devices, such as to display visual information (e.g., images, graphical user interfaces, videos, notifications, and the like) to the user, and in certain instances may also act to receive user input (e.g., via a touch screen or the like). The display may be a liquid crystal display screen, plasma screen, light emitting diode screen, an organic liquid emitting diode screen, or the like. The type and number of display may vary with the type of devices (e.g., smartphone versus a desktop computer).

The memory components 116 store electronic data that may be utilized by the computing devices, such as audio files, video files, document files, programming instructions, and the like. The memory components 116 may be, for example, non-volatile storage, a magnetic storage medium, optical storage medium, magneto-optical storage medium, read only memory, random access memory, erasable programmable memory, flash memory, or a combination of one or more types of memory components. In many embodiments, the server 106 may have a larger memory capacity than the party devices 102, 104, 108, with the memory components optionally linked via a cloud network or the like.

The network interface 118 receives and transmits data to and from the network 110 to the various party devices 102, 104, 108 and the server 106. The network/communication interface 118 may transmit and send data to the network 110 directly or indirectly. For example, the networking/communication interface may transmit data to and from other computing devices through the network 110 which may be a cellular or other wireless network (WiFi, Bluetooth) or a wired network (Ethernet), or a combination thereof. In some embodiments, the network interface may also include various modules, such as an application programming interface (API) that interfaces and translates requests across the network 110 to the specific local computing elements for the various party devices 102, 104, 106.

The various computing devices 102, 104, 106, 108 may also include a power supply 120. The power supply 120 provides power to various components of the computing devices 102, 104, 106, 108. The power supply 120 may include one or more rechargeable, disposable, or hardwire sources, e.g., batteries, power cord, or the like. Additionally, the power supply 120 may include one or more types of connectors or components that provide different types of power to the computing devices 102, 104, 106, 108. In some embodiments, the power supply 120 may include a connector (such as a universal serial bus) that provides power to the computer or batteries within the computer and also transmits data to and from the device to other devices.

The input/output interface 122 allows the party devices 102, 104, 108 to receive input from a user and provide output to the user. For example, the input/output interface 122 may include a capacitive touch screen, keyboard, mouse, stylus, or the like. The type of devices that interact via the input/output interface 122 may be varied as desired.

It should be noted that the various computing devices may be in communication with a compute back end, such as the server 106 or a cloud provider, e.g., Google Cloud Platform, Amazon Web Services, Microsoft Azure, or the like.

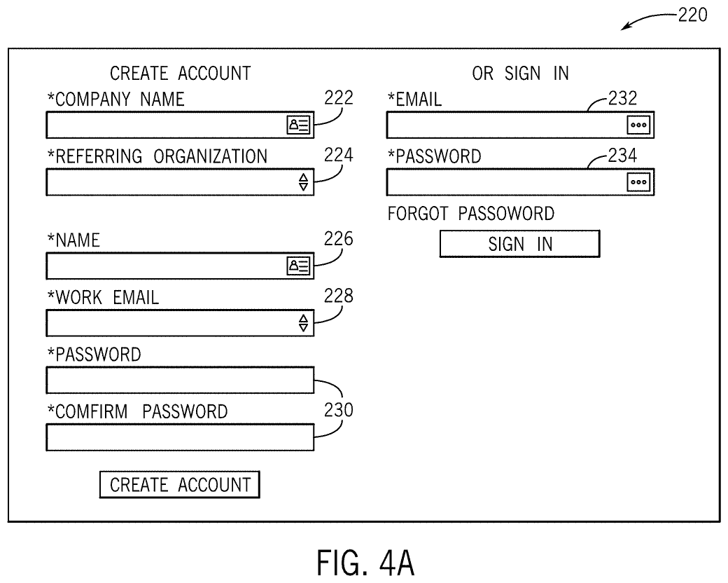

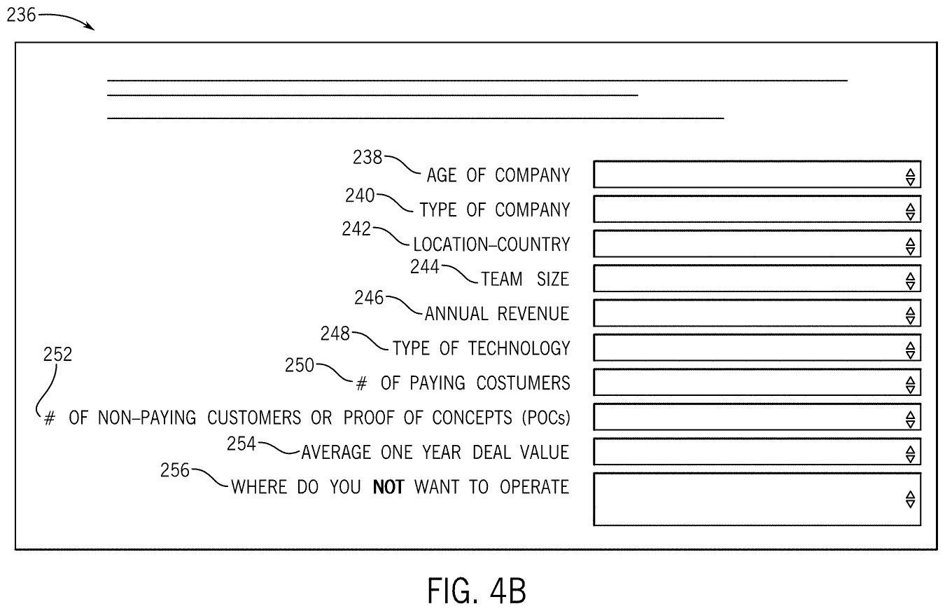

Various methods to utilize the system 100 to automatically generate contracts will now be discussed. FIG. 2 is a flow chart illustrating a method 200 to receive party information and generate individualized contracts and/or provisions. The method 200 may begin with operation 202 and the server 106 receives party or entity information. FIGS. 4A and 4B illustrate examples of user interfaces that can be displayed on the first party device 102 in order to allow the user to enter the information into the system.

As shown in FIG. 4A, a login user interface 220 is displayed on the first party device 102 and includes input fields, allowing a user to input information corresponding to the first party. In particular, the login user interface 220 includes a company name field 222 where the user can enter in the name of the first party entity, e.g., the legal entity that will be bound by the generated contract or provisions. The login user interface 220 also includes a referring organization field 224 where the first party can optionally include a referring organization, such as another party, that has directed them to the platform or system 100. As can be appreciated, the data input via the referring organization field 224 can be used to provide feedback regarding the first party, especially in instances where the first party may not be well known or known to the organization or host. Additionally, the login user interface 220 may include identification and contact fields, such as a name field 226, email field 228, and password input and confirmation fields 230. Information entered by the user into these fields can be used to generate a first party entry into a party database on the server 106, which allows the user to enter information into the system, control and provide inputs regarding contractual action items, and view status, etc. For example, once the user has generated an entry in the system database corresponding to its party, the user can directly login into the system such as via the sign in fields 232, 234 where the user enters his or her email and password, which is then validated with the party database on the server 106, and if correct, allows the user to view information corresponding to their represented party.

In some embodiments, the party information may include the user information representing the party on the system. In these instances, the user's name, title, role, and/or other information may be received from the user or pulled automatically (e.g., from social media, such as LinkedIn, or from internet searches, etc.). A party may have multiple users authorized to enter contracts on behalf of the party and the system may track and store feedback regarding different users for the party to be able to provide input regarding particular provisions, terms, or agreements based on the user information.

After the user has created a user name in the party database and/or after logging into the system, a party information graphical user interface can be used to receive information for the party or entity as input by the user. With reference to FIG. 4B, a party information user interface 236 is transmitted by the server 106 to the first party device 102. In this example, the party information user interface 236 may include one or more company data fields configured to receive information directly from the user representing the contracting party. Examples of party fields can include, age of the company 238 (e.g., years in operation), type of company 240 (e.g., LLC, Ltd., Inc., etc.), location 242 (e.g., city, state, country, or the like), team size 244 (e.g., number of employees, number of employees or persons in the contracting entity, etc.), annual revenue 246, type of technology 248, number of paying customers 250, number of other customers 252 (e.g., non-paying or proof of concept customers or users), average one year deal value 254 (e.g., average values of deals that the company has previously executed or is looking for), number of current pilots, industry (hardware vs. software vs. tech enabled services), revenue per month, experience of founders and other key employees, money values and class raise (e.g., friends and family vs. series A vs. series B), growth rate, board structure (e.g. private vs. public), and optionally areas where the company does not want to operate 256, such as excluded regions, or the like. The company fields are selected to receive information directly into the system from the first party user regarding the first party or contracting party. In some instances the fields may be open, allowing a user to provide a textual input, but in other examples, the fields may be varied and include drop down menus, receive URL links, selectable options, or the like. It should be noted that the system may also detect input characteristics on the website itself, such as user interactions and timing when inputting the information to the specifically presented questions as additional party data, e.g., time to enter information, number of key strokes, and the like, on each of the different questions to further assess personality and party inferences.

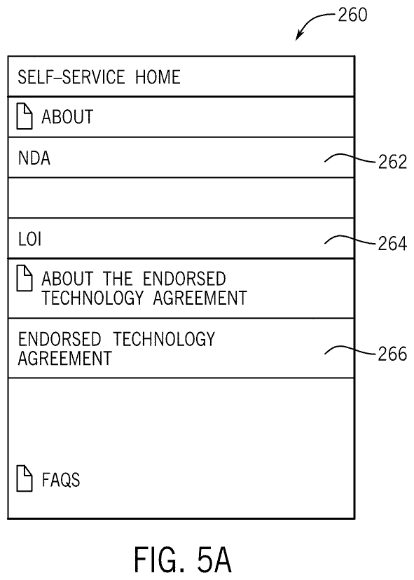

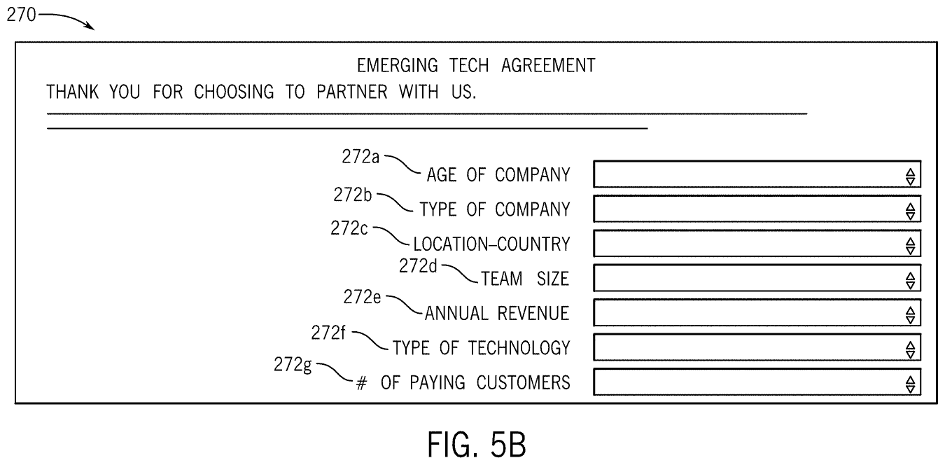

The information received regarding the first party as input directly by the user is then transmitted to the server 106 and correlated to the party entry in a party database. With reference again to FIG. 2, once the party information is received, the method 200 may proceed to operation 204 and a first party selection of the agreement type is received. For example, FIG. 5A illustrates an agreement selection user interface (UI) 260, which is transmitted by the server 106 to the first party device 102. Utilizing the agreement selection UI 260, the user can input a selection regarding the type of agreement, contract, provisions, and/or terms that the party is looking to generate. For example, as shown in FIG. 5A, agreement options such as a non-disclosure agreement section 262, letter of intent selection 264, and an endorsed technology agreement selection 266 are displayed as user-clickable buttons. In this example, the user provides an input to the first party device 102 to select the desired agreement section option. However, in other embodiments, the user may input the agreement type via other inputs, e.g., textual, drop down, multiple choice, or the like. As such, the form of the agreement input should be understood to be variable as desired. In the different embodiments, the input agreement selection is then transmitted via the network 110 to the server 106. It should be noted that in some embodiments, the system may make automatic selections of agreement types depending on the party information. For example, if the party is a new user to the system 100, the first agreement may always be selected to be a non-disclosure agreement or other type of initialization agreement that sets a baseline framework.

With reference to FIG. 2, once the server 106 receives or identifies the agreement selection from the first party 102, the method 200 may proceed to operation 206 and optionally any additional party questions specific to the selected agreement are generated by the server 106. For example, the certain agreement types may require additional party information in order to generate the selected provisions, where the input of the information at the initial party stage may not make sense since the information is specific to those agreements and requiring the information to be input at every stage could slow down the process. It should be noted that the questions may be related to earlier entity general questions or even other questions provided in the grouping, the relation may be used to provide additional data for the entity.

In some instances, the questions presented to the users may be dynamically generated based on previous answers. For example, a machine learning algorithm including a natural language processor, can analyze received answers and characteristics to determine follow-up or other related questions to be presented to the user, e.g., if the server receives a first answer to question A, then the first answer will drive the server to output question G, rather than question B. By dynamically modifying the questions based on previous questions and answers, the system can tailor the entity characteristics received to better questions that will be useful in generating the agreements and contracts.

FIG. 5B illustrates an example of an agreement specific information request UI including multiple agreement specific party fields 272a, 272b, 272c, 272d, 272e, 272f. The agreement specific party fields 272a, 272b, 272c, 272d, 272e, 272f are selected based on the agreement selection, in this case an emerging technology agreement, where the technology of the first party may be licensed or otherwise leveraged by a third party via the generated agreement. The agreement specific fields are selected based on provisions of the agreement, rather than background or general information of the party in general. In this example, the fields include inputs corresponding to company age 272a, type of company 272b, location 272c, team size 272d, annual revenue 272e, type of technology 272f, and number of paying customers 272g. In some embodiments, the agreement specific fields may be limited to the business unit or technology at issue, e.g., the technology being licensed, and so certain information while somewhat related to the overall party information collected as part of the entity or party profile, may be more narrowly defined. In instances where there may be overlap between the entity profile and the requested agreement information, the system 100 may populate the information automatically in the requested fields or may populate the information directly into the algorithms (i.e., not display a field at all for user input).

As can be appreciated, the example shown in FIG. 5B is meant as illustrative only and other formats as well as agreement specific information questions may be presented depending on the type of company or entity, the agreement, and the like.

With reference again to FIG. 2, the method 200 proceeds to operation 208 and the user or party answers and other information are received by the server 106. For example, as the user enters information into the various agreement specific party fields 272a, 272b, 272c, 272d, 272e, 272f, which may be displayed as a webpage in communication with the network 110, the first party 102 device then collects the data and transmits the data via the network 110 to the server 106. Additionally or alternatively, the server 106 may retrieve party specific information needed for the agreement from the entity or party profile database.

The method 200 then proceeds to operation 210 and the server 106 analyzes the party information received and determines supplemental party or entity characteristics that will be used for the agreement and/or party profile. For example, certain answers or characteristics may require follow-up or link to additional questions, e.g., if a user answers “no” to a question on expected funding, no additional funding questions may need to be retrieved, but if the user answers “yes,” additional questions related to the expected time frame of a new funding round and desired funding amounts may be retrieved and served to the user via the first user device 102.

As another example, the server can analyze the party information along with agreement specific information, such as the technology specific information, and generate additional characteristics corresponding to the first party. These characteristics may be probabilities, such as a likelihood of success, anticipated next funding rounds, commercialization timelines, expected growth, etc., that may be determined based on a comparison of other similarly situated entities over time and past and future behavior of those entities. In this manner, the supplemental or determined characteristics may be dynamic and updated as additional feedback is provided to the system 100, either directly via other entities stored in the system or indirectly, such as changes in third party databases, information via web-scrubbing, business reporting and valuations, detected trends, and the like.

The method 200 then proceeds to operation 212 and the entity data, including the user profile, the agreement specific information, as well as determined characteristics is stored in the memory of the server 106.

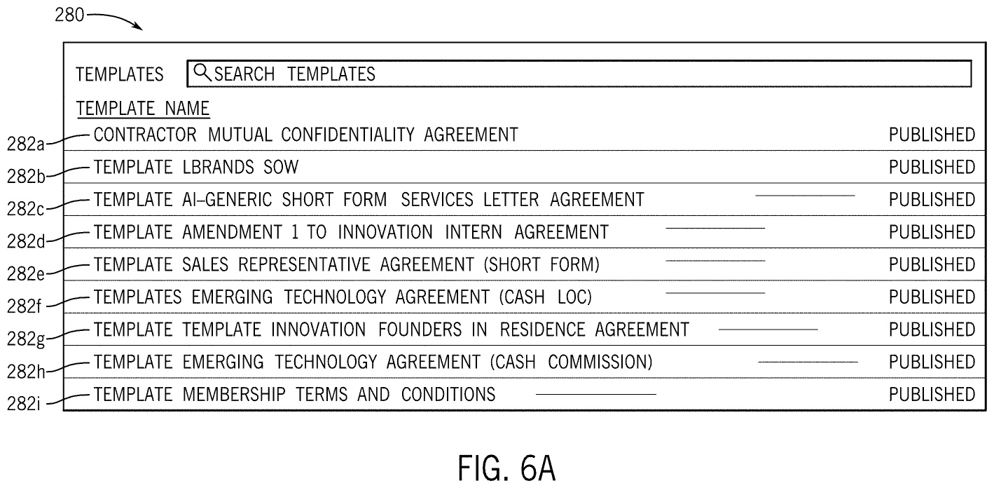

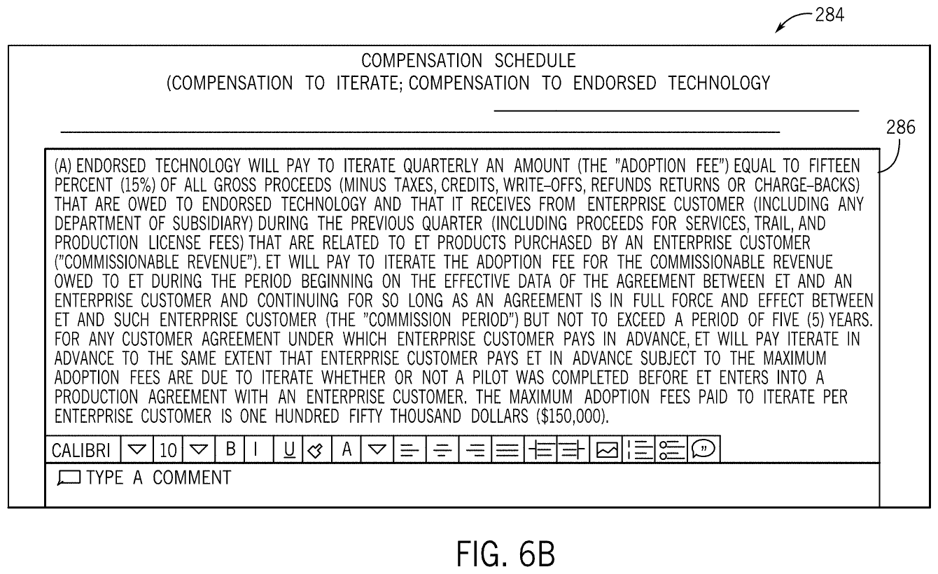

The method 200 then proceeds to operation 214 and the server 106 generates a contract, other agreement, and/or selects provisions to include in an agreement. In one embodiment, the system 100 may include a plurality of agreement templates or forms stored in a memory location and the algorithm analyzes the received party and entity information to select a best fit from the stored agreement templates or provisions. FIG. 6A illustrates a template store 280 illustrating a plurality of agreement templates 282a-282i. As shown in FIG. 6A there are a variety of agreement templates that may include metadata or other tagged information that allow the server 106 to select the agreement for the particular party and situation. The tagged information can be by template agreement, type, category, heading, ranking of provision, and other data corresponding to frequency of use and location. FIG. 6B illustrates an example an agreement framework 284 that includes selectable provisions 286. In this example, the various provisions are stored with metadata or other reference characteristics that allows the server 106 to be able to select the desired provision, as well as a reference to different agreements and locations within those agreements or templates where the provisions can be inserted. For example, a first provision may include metadata tying the provision to entities with a determined set of characteristics, as well as data pointing to the agreement templates and locations where the provision can be inserted. Similarly, the data pointing to the agreements can be done by agreement type, category, heading, ranking, use information, and the like. The data stored with agreements and provisions may be stored in a variety of ways, including reference tables, metadata, or other tagging.

In some embodiments, the system may further be configured to modify term or elements of a provision. For example, a provision may include a non-compete for X years, and the system may be able to select the years element to fill in for a particular provision. In this manner, the system may store options of the elements or may dynamically generate an element based on other information.

Once the contract is generated in operation 214, the server 106 may store and/or transmit the contract to the first party, the hosting entity, and optionally the third party that will be executing the agreement with the first party. The type of output may be varied depending on the situation, but often, once the agreement is generated, both the first party and the third party will receive alerts on the respective devices of the agreement and either a link to the agreement, a copy of the agreement, or the like.

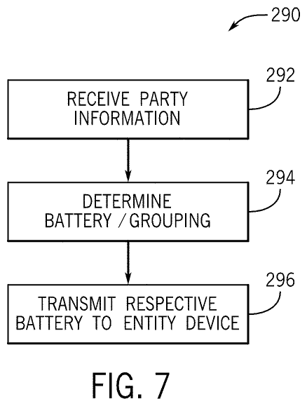

As discussed with respect to operation 206, to generate the contract, the server 106 may select agreement or party specific questions to present to the entity (e.g., via the user interface). FIG. 7 illustrates an example flow diagram for a method 290 of determining the questions to present to the first party device 102. As shown in FIG. 7, the server 106 receives the party information in operation 292, such as via the party profile, the additional information entered directly by the party user, retrieved from the system 100 environment (e.g., as input relative to the agreements or interactions within the ecosystem or platform of the host), and/or from third party sources. With the party information, in operation 294, the server 106 determines a categorization for the entity. For example, the server 106 analyzes the entity information and compares the information to a plurality of company “buckets” or categories. In one example, the battery or grouping categorization selected is those in which the company has the most number of similar characteristics. In operation 296, the server 106 can transmit the battery, grouping, or categorization to an entity device.

Examples of the categorization features include funding ranges, types of funding received, number of employees, technology, or the like. For example, Category A may include the following characteristics: funding between $700,000 to $1.1 million, software as a service (SaaS) technology, 2-6 employees, and 1-2 years in operation, Category B may include the following characteristics: funding between $900 to $1.4 million, hardware and software technologies, 5-10 employees, and 2-5 years in operation, Category C may include: funding between $1.3 million to $2 million, SaaS and software platforms, 2-20 employees, and 2-7 years in operation. Using the various category characteristics the server 106 can analyze the inputted data and select a category in which to drop the entity or party, which could be by a most number of matching characteristics, as well as threshold variation (e.g., within 10% of certain top or bottom thresholds), etc.

In other examples, the server 106 can use the party information to determine an entity characteristic related to risk categorization or class for the entity. The server 106 can determine agreement templates, provisions, addenda, amendments, or riders based in part on the risk class assigned to the entity. Some risks associated with an entity can be the risk of fraud, insolvency, criminal activity, or lack of compliance with one or more civil laws or regulations. Nearly any regulation or law can affect an entity's risk. Some specific, non-limiting examples are: labor laws, import/export controls, intellectual property laws (e.g., patent, trademark, copyright, trade secret); environmental laws, privacy laws, or the like. In some specific examples, an entity may perform work that involves privacy regulations, such as the California Consumer Privacy Act (CCPA), the Global Data Protection Regulation (GDPR), or other similar regulations. A number of factors may influence the risk that the entity poses with respect to compliance with regulations. For example, some factors that can affect the risk associated with an entity can be: whether the entity collects, processes or stores data on individuals; whether the entity has processes in place to comply with individuals' right to notice, right to access, right to opt in or out, right to delete data, and right to equal services; whether the entity has robust security measures in place to prevent data breaches, or has experienced data breaches in the past.

Other factors that may affect an entity's risk class can be attributed to a technology that the entity develops, sells, or provides. For example, if an entity develops medical devices, it may be at a higher risk for class action lawsuits such as product liability lawsuits related to defects in those medical devices as compared to a company that develops software. In another example, if a company develops self-driving cars, that company could face increased personal injury litigation risks as compared to software as a service entities. An entity's risk class can be affected by its business strategy. For example, an entity that invests in sub-prime mortgages could be at risk of insolvency or bankruptcy if economic conditions cause a large number of those mortgages to go into default. An entity's risk class can be affected by its operation mode. For example, an entity that has mining operations in countries with unstable governments may face the risk of having those operations seized or nationalized. Similarly, a company that collects, stores, sells, or analyzes user data, such as data collected by a website, email or online platform could be at risk of data breaches or other activities that could result in penalties under laws such as the GDPR or CCPA. In this manner, the type of company, products, industry, location, and the like, can all be categories including a legal risk factor that may be increased or decreased depending on the entity characteristics. As the legal landscape changes across different categories, such as due to the development of new laws or other changes, the system may reassess and update the values, weights, and scores applied for the various categories and entities.

After the server 106 determines the selected category for the entity, the sever 106 retrieves the selected follow-up questions to be presented to the entity by a UI transmitted to the first entity device 102. It should be noted that the entity categorization described above can be applied to the selection of agreement templates or provisions, such as the assessment done in operation 214.

Additionally, as noted above, in some instances, a machine learning algorithm may utilize a natural language processor to dynamically generate questions as well. The additional questions may be based on the input answers to the previous questions, such that the next presented questions are variable and selected to receive more specific information for the contracting party.

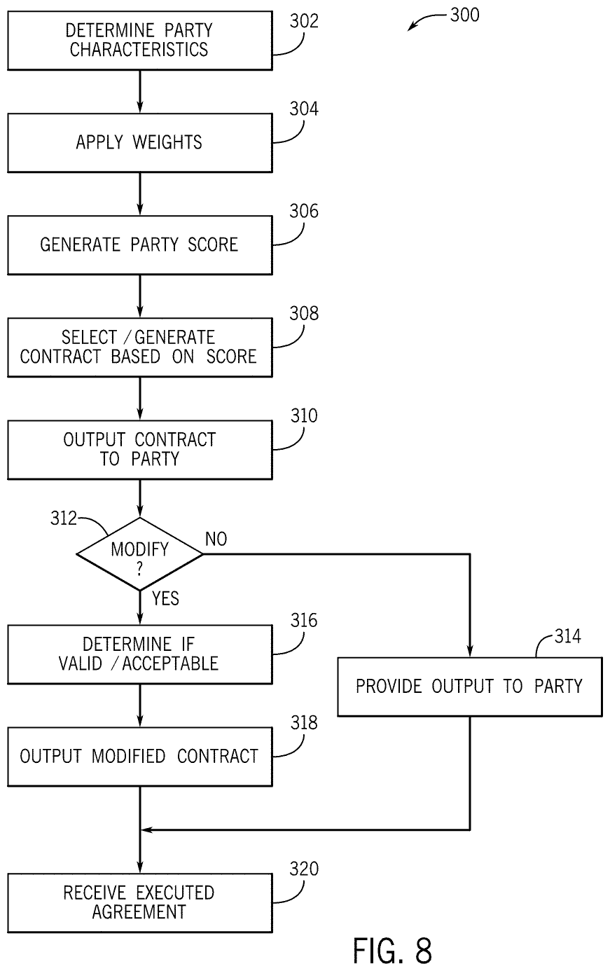

FIG. 8 illustrates a specific example of utilizing the entity information to generate agreements or provisions. The method 300 may begin with operation 302 and the entity characteristics are determined. For example, as described above the server 106 may retrieve the party characteristics from information entered via the first user device 102 (either when generating a profile or during additional data entry points, e.g., supplemental questions as part of a new agreement), from data collection of the entity's interactions within the system 100 and other related tracking elements, and/or from third party sources, such as social media, the Internet, new sources, and the like. The entity information may also include feedback or engagement information with the system 100. For example, over time the system 100 may track a particular entity's performance and interactions with other parties within the system 100 and use this information as a separate characteristics that can be evaluated to improve or lower an entity's score.

In some embodiments, the specific user engaging with the system on behalf of the entity and corresponding user information may be used as additional characteristics. For example, if the user's behavior over time with the system is to quickly and easily approve provisions, the system may use such information to present provisions that are less favorable to the entity. As another example, if the specific user enters a title of a “general counsel” for the entity the user may be presented with select provisions or a contract from that is not presented to “founder” or “engineer.” In other words, a user's title may be used as a characteristic by the system.

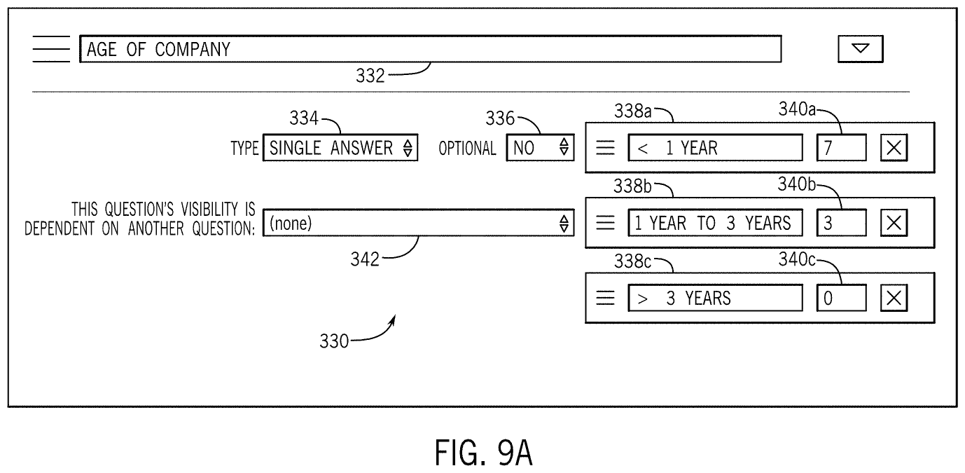

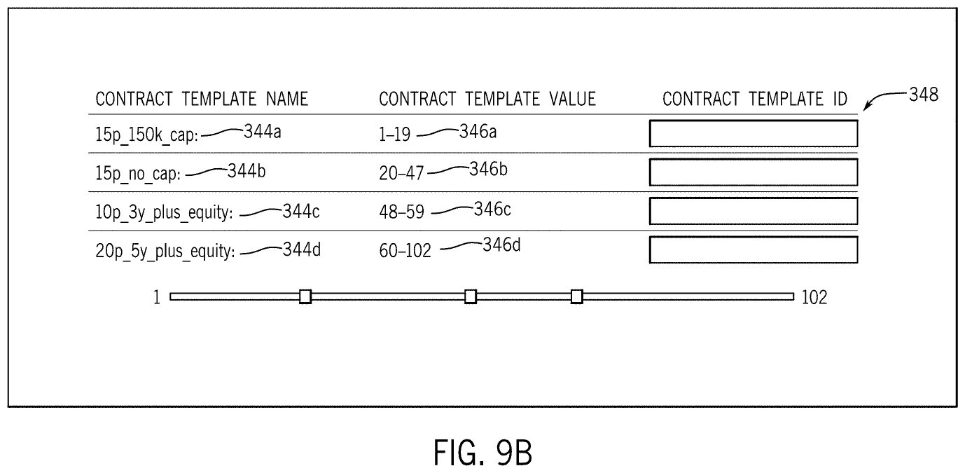

The method 300 then proceeds to operation 304 and the server 106 applies values and weights to the entity characteristics. With reference to FIG. 9A, an example of a value function is shown on UI 330. In this example, an entity characteristic 332 is assigned various values 340a, 340b, 340c, depending on the selected characteristic for the select entity. Specifically, a numerical value is assigned to the entity characteristic depending on where the entity falls within the characteristic categories 338a, 338b, 338c value ranges or answer category. In this example, if the entity has an age that is less than 1 year (characteristic category 338a), then a first value 340a (value of 7) is applied, if the entity has an age falling between 1 to 3 years (characteristic category 338b), then a second value is assigned 340b (value of 3), and if the entity has an age that is over three years (characteristic category 338c), then a third value is assigned 340c (value of 0). In another example, the entity characteristic 332 can be a risk class or weighted risk value. A numeric or qualitative ranking can be assigned to a risk class, such as “high”, “medium”, “low” and/or a value associated with a likely risk in a particular category, e.g., growth risk, legal risk, financial risk, and the like. The values or scores that are applied to the characteristic categories or buckets may be varied dynamically by the system 100 as new information is input, such as feedback into the system, and the like. Additionally, while the scores are assigned per characteristic, in some instances, the scores may be dependent on multiple characteristics, e.g., a first characteristic value may receive a first score value, unless a second characteristic value is below or above a threshold and then a second score value may be applied to the same characteristic.

To that point, it should be understood that FIG. 9A illustrates a single characteristic and the values applied thereto. The system may complete such an analysis for all the entity characteristics that are considered for the agreement. This may range from 3 to 20 or more characteristics, with each company or entity characteristic being given a value depending on the “bucket” or category that the specific entity falls into. In some embodiments, the values or scoring applied may be done via a machine learning or other modeling approach, where the past historical information on tagged provisions or characteristics are simulated multiple times and use the simulations to output a particular algorithm that values the characteristics, and weights the characteristic, automatically or otherwise defines the relationships between the provisions and particular party characteristics.

Additionally, as shown in FIG. 9A, are examples of the characteristic types 334 (e.g., single answer versus multiple answers), and whether the questions are presented to the user as being optional or not (optional characteristic 336), as well as whether the questions visibility depended on another question (see dependability characteristic 342). These question based characteristics 334, 336, 342 may be used to also adjust the values as needed, depending on the question type, etc.

The system may calculate a score for each entity, based on the value of each characteristic as well as the weighting of each characteristic, where a characteristic weighting is based on a statistical model of influence that particular characteristic is determined to have on an optimally generated contract and contract provisions for an entity based on similar entities. An example of this might be an entity characteristic of age of entity. The various enumerations of age characteristics, such as less than 1 year, 1 to 3 years, and older than 3 years, may have a calculated value that would then be weighted by the statistical model of the influence of the age of entity characteristic calculated from prior entity and contract and provision pairings. In other words, the characteristics may be weighted differently within the system, such as by assessing the values of characteristics in a statistical model.

With reference again to FIG. 8, after the characteristic values are applied to the various entity characteristics, and the weighting of each characteristic is applied, the method 300 proceeds to operation 306 and the entity score is generated. For example, the server 106 may sum the values applied for all the entity characteristics (with the appropriate weighting for each characteristic) and use the result to determine a final total or sum, which may then be determined to be the entity score. For example, if the entity or party has the following characteristic values: first characteristic value “3”, second characteristic value “9”, and third characteristic value “1”, the scored sum will be “13”, where all the characteristics are weighted the same. In another embodiment, the third characteristic may be weighted differently from the other two, resulting in a different final score. The scoring process may also take into account characteristic values that are dependent on other values, e.g., the dependency effect is applied during the scoring operation, rather than during the value application operation (operation 304).

The method 300 then proceeds to operation 308 and the sever 106 selects or generates a contract, provision, term, or other agreement based on the entity score. For example, the server 106 may compare the entity score to contract or provision values to select the contract for the entity. FIG. 9B illustrates an example of various agreement templates 344a, 344b, 344c, 344d with assigned agreement values 346a, 346b, 346c, 346d. The server 106 then compares the entity score to the agreement values 346a, 346b, 346c, 346d and determines which agreement to select, e.g., an entity score of 13 will fall within the first agreement value range 346a. The server 106 then accesses the selected agreement 344a, 344b, 344c, 344d, such as by referencing an agreement identifier or location within an agreement database, see e.g., agreement identifier 348 in FIG. 9B.

In instances where the score is used to select provisions, operations 306 and operation 308 may be repeated for the desired number of provisions in the agreement and the operation 308 may then also include a “building” of the agreement by combining the selected provisions or provision terms into a form template or the like. For example, if an entity has a high score in a risk class or category, certain contract provisions providing indemnity for such risks can be included in the contract, e.g. above a particular value of risk, a risk reduction, indemnity, or other provision may be selected for inclusion in the agreement.

With reference again to FIG. 8, once the agreement is generated by the sever 106, the server 106 outputs the agreement to the first party device 102 and optionally the third party or contracting party device 108. For example, the server 106 may transmit an editable version of the agreement, a non-editable version (e.g. PDF) as a copy via an email download or download link. As another example, the server 106 may transmit a link to an electronic display of the agreement, such as a webpage or the like, in these instances the electronic display may include an execution or electronic signing environment. These instances allow the first party 102 to immediately and easily execute the delivered agreement.

After the first party device 102 and optionally the third party device 108 has received the agreement, the method 300 may proceed to operation 312 where the server 106 determines whether the agreement is to be modified. For example, the first party user may review the agreement on his or device 102 and request revisions to select provisions, additions, or other variations to the agreement. As another example, in instances where the third party device 108 receives a copy of the agreement as well, the third party (via a user) may transmit requested revisions, additions, or other changes. Accordingly, in operation 312, the server 106 determines whether any change or modification requests have been received by any of the party devices 102, 104, 108. If no modification requests are received, the method 300 may proceed to operation 314 and the server 106 may provide an output or other notification to the first party device 102 stating that there have been no suggested changes, etc., and that the agreement is in form for execution.

With reference to FIG. 8, if in operation 312, the server 106 receives modification requests, the method 300 proceeds to operation 316 and the modifications are analyzed to determine if they are acceptable. In one example, the server 106 may request confirmation for the contracting or third party, such as by sending an accept or deny request to the third party device 108. In this example, the third party or contracting party (in some instances may be the host party 106), can determine whether to accept, deny, or further modify the proposed change. The server 106 can then relay the outcome of the change request back to the first party device 102. In another example, the server 106 may compare the proposed modification to a category of acceptable changes, e.g., compare a change in term length to a threshold of term length variations for the contracting party or agreement type, to automatically determine whether such changes are valid or acceptable. Along this vein, in some instances, certain categories of provisions or changes, such as changes to a services definition, an appendix, or other selected provisions, may be automatically accepted.

In other examples, the server may analyze the changes via a natural language processor or other similar algorithm that compares the changed words, meaning, and/or grammatical rules to determine if the changes result are of form rather than substance or under a threshold value and then may be approved. As another example, the changes may be compared to stored acceptable changes and then if the changes matches a previously stored redline (or other tracked changes format showing revisions), the redline may be accepted. In yet another example, if changes are requested, the server may reject the changes, but automatically pull the next step lower provision stored in memory. For example, if there are three template provisions stored, with three different values assigned (1 to 3) and the party is served the provision 3, which is the most restrictive and provides changes to the provision, the system may disregard both provision 3 and the changes and transmit the next stored provision, provision 2, which is a known provision already determined to be acceptable by the system. In this example the system may not need to evaluate actual changes input by a party, but rather use the fact that there are changes in a provision to serve up a new provision.

If there are changes to the agreement, the method 300 proceeds to operation 318 and the server 106 outputs the modified agreement back to one or all of the parties, e.g., the first party device 102, the third party device 108 and optionally the host party device 104. With the finalized agreement received by the designated parties to be bound by the agreement, such as after operation 318 and 314, the server 106 then transmits an execution request to the respective party devices. The execution request may include a link to an electronic signature platform (e.g., DocuSign), or otherwise provide an electronic signing capabilities for the user.

From operation 318, the method 300 may proceed to operation 320 and the server 106 receives an executed copy of the agreement from the contracting parties, e.g., from the first user device 102 and the third party device 108.

In other embodiments, the system may utilize other models or methods to assess the party characteristics to build a particular agreement. For example, a linear regression model may be utilized to score and cluster party characteristics in order to either select provisions or terms for an agreement and/or select a particular agreement template. Further, as noted, in various embodiments, machine learning algorithms may be used that utilize various characteristic values and weights to determine an optimal matching of contracts or provisions to entities.

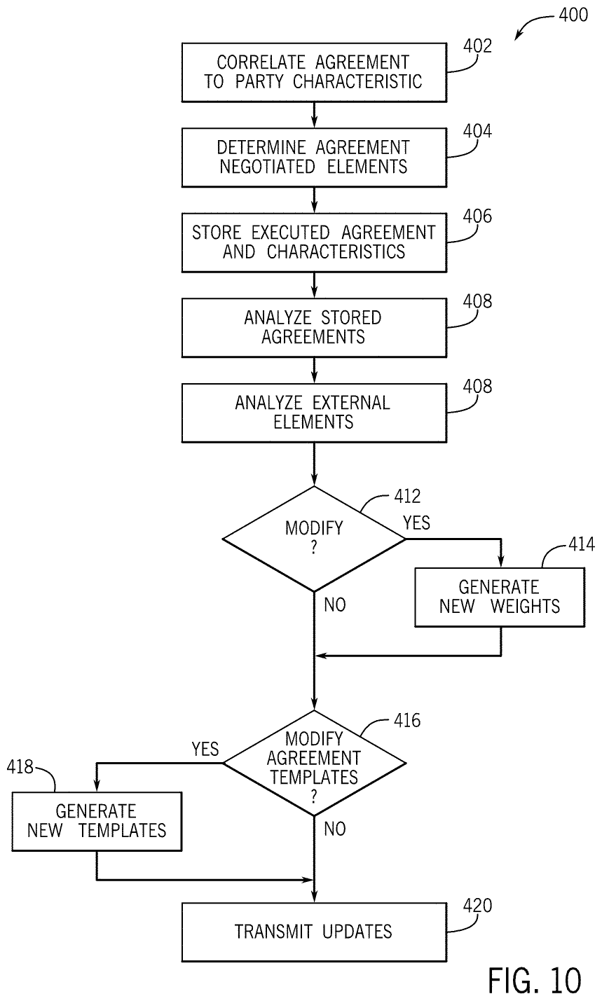

As mentioned, in some implementations the system 100 and platform may utilize feedback to dynamically update agreement provisions, values, scoring, weighting, and analyzed characteristics. FIG. 10 illustrates a flow chart for leveraging or incorporating feedback into the dynamic agreement generation platform. With reference to FIG. 10, the method 400 begins with operation 402 and the server 106 generates one or more tables or other reference structures that correlate agreement provisions of finally executed agreements to party or entity characteristics of the contracting parties. The method 400 also includes operation 404 where the server 106 further analyzes or identifies negotiated or otherwise varied provisions within the agreements, e.g., the server 106 compares the agreement as originally delivered to the executed copy. The server 106 then stores in a memory location the executed agreement characteristics along with the party characteristics of the parties that were bound by the executed agreement.

Using the variations and party characteristics, the server 106 analyzes the agreement to detect trends or other statistically significant patterns. Similarly, the server 106 may also in operation 410 consider and analyze external elements as well. The external elements include trends in the marketplace, variations in technology, company or entity information (e.g., updates in financial status, revenue, growth, and the like), types of venture capital money investments with the startup, and the like. External elements can also include changes of law or policy that may affect agreements generated by the system. Sources of change of law information can include, for example, decisions from courts of law, equity, or administrative courts; new, changed or expiring regulations; statutes passed by legislative bodies and enacted by an executive body; tariffs; treaties; decisions by international bodies such as the United Nations, the International Trade Commission and the like; changes in monetary policy from central banks such as the Federal Reserve or the European Central Bank.

After the assessment in operations 410, 412, the method 400 may proceed to operation 412 and the server 106 may determine whether the scoring for various identified characteristics should be modified. For example, where the value assigned for selected characteristics should be increased or decreased. As a specific example, if during a comparison of all previously executed agreements the server 106 determines that for companies that are 1-3 years in age, the term length was extended from the original term by 1 year in 75% of the contracts, the server 106 may determine that the 1-3 year characteristic should be given a new value that may increase or decrease the overall score, trending towards another term provision value for the agreement. It should be noted that the values may be done on a provision by provision basis or may be done by the agreement as a whole. As another example, if during the analysis the server 106 identifies that SaaS type of technology companies tend to have reached more preferable terms in the final executed agreement, the server 106 may determine that the technology value for SaaS companies should be increased or decreased to result in a more favorable agreement for SaaS companies. In another example, if certain entities have been assigned a value based on risk of compliance with the CCPA, and a new version of the CCPA is enacted, the server 106 may determine that the values for entities of those types should change. In other words, as the legal landscape changes, the system may re-evaluate entities with certain risk levels or values to update the estimated risk and then may update the provisions in the contract accordingly.

If the server 106 determines new values should be generated, the method 400 proceeds to operation 414 and the new values are created and updated in the system. Relatedly, the system may use a similar process to update the weighting of values as desired.

After operation 412 or 414, the method 400 may proceed to operation 416 and the server 106 may determine whether any of the agreement templates should be updated, or patched, in light of the analysis and feedback. For example, if a threshold value of executed contracts all remove a provision or modify a provision in the same manner, the server 106 may update the stored template or reference agreement to include a modified provision or remove the provision. In instances where the changes to the agreement provisions exceed a predetermined threshold, the method 400 proceeds to operation 418 and the server updates the template agreements accordingly. If on the other hand the changes are determined to below a threshold or other statistical assessment indicates that the provisions should not be changed, the method 400 ends and/or transmits any updated scores to agreements to the databases or memory locations in operation 420. In another example, if, due to a change in an external element, such as a change in law affects values and scores for agreements, the server 106 may update the agreement templates to reflect the change in law or other external element.

In addition to updating templates, e.g., for contracts that may be executed in the future, the server 106 can also determine whether a change should be generated for previously executed contracts, such as due to an external element, new data points within the system, and/or other changes. For example, the server 106 can analyze the provisions of an executed contract, and flag those that may need to be changed in light of external factors. The server 106 could generate patches to update, modify, or correct those provisions. Continuing the example of an external element like a change in law, such as a privacy law like the CCPA, an entity could have previously executed a contract without any provisions related to the CCPA. This situation could occur, for example, if the contract predated the CCPA. This situation could also occur if a party to the contract started doing business, or having other minimum contacts, in a new jurisdiction. For example, suppose an entity decided to begin doing business in Europe, or with European citizens, and its contracts had no provision related to the GDPR. In such cases, a contract may need to be patched, such as by providing a rider, amendment, or addendum for the parties to execute thereby providing appropriate provisions related to the external elements such as a change in law or jurisdictional contacts.

The server 106, can analyze the external elements, such as in operation 410, and generate patches for the contracts for multiple entities, based on the entities' categories or buckets determined for example in method 290. The server 106 can patch executed contracts for some or all of the entities falling into certain categories, buckets, or batteries. For example, if companies are in a “high” risk category for privacy issues for instance because they collect, store, analyze, use, or sell user data, they may receive a patch to their existing contracts based on external factors such as a change of law like the GDPR, CCPA, or the like. The entities can receive and execute and return such contract patches via methods of the present disclosure.

Utilizing the method 400, the agreement generation platform and system can dynamically update template agreements to account for trends in both the parties and specific provisions in the agreements. This allows the system to reduce negotiation time and back and forth between the parties, helping to expedite parties through the legal process of contract execution and move to the business relationship.

In some examples, the system may utilize feedback dynamically during the initial agreement drafting operations based on user interactions with the system. For example, the system may present contract provisions one by one or in groups (e.g., all provisions related to indemnity or intellectual property are displayed together). In this example, the system may use the response time of the user in analyzing each provision or groups of provisions to dynamically adjust further provisions within the contract. As a specific example, if the user takes over a predetermined amount of time or exceeds an average review time for a provision, the system will select different provisions, such as those that are less “lawyerly” or are more friendly to the party on the assumption that the user is having a difficult time understanding the concepts and/or is resistant to agree to the provisions.

The foregoing description, for purposes of explanation, uses specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

1. A method to generate an agreement between two or more parties, comprising:
receiving by a processing element a plurality of entity characteristics corresponding to at least one of the two or more parties;
analyzing by the processing element two or more of the entity characteristics;
utilizing by the processing element the analyzed two or more characteristics to identify a first agreement from two or more agreements; and
outputting by the processing element the first agreement to a first user device corresponding to at least one of the two or more parties.

2. The method of claim 1, further comprising:
generating by the processing element an entity score by combining the two or more characteristics; and
comparing by the processing element the entity score to two or more agreement score ranges corresponding to the two or more agreements, wherein the entity score falls within the an agreement score range corresponding to the first agreement.

3. The method of claim 1, wherein the entity characteristics are received directly or indirectly.

4. The method of claim 1, further comprising:
receiving by the processing element a proposed modification from at least one of the two or more parties;
vetting by the processing element the proposed modification to determine acceptability; and
updating the first agreement to include the proposed modification.

5. The method of claim 4, wherein vetting comprises:
transmitting the proposed modification to the other of the at least two or more parties; and
receiving an approval of the proposed modification from the other of the at least two or more parties.

6. The method of claim 4, wherein vetting comprises:
comparing the proposed modification to a category of acceptable modifications; and
determining that the proposed modification falls within the category of acceptable modifications.

7. The method of claim 1, wherein analyzing the two or more of the entity characteristics comprises:
determining a weighting of values for the two or more entity characteristics; and
based on the weighting, summing a score of the values for the two or more entity characteristics, wherein the score is utilized by the processing element to identify the first agreement, respectively.

8. The method of claim 1, wherein analyzing the two or more entity characteristics comprises weighting values of the two or more entity characteristics by a statistical model to determine the entity score.

9. The method of claim 1, wherein the entity characteristics comprise an entity risk.

10. The method of claim 9, wherein the entity risk is related to compliance with a privacy regulation.

11. A method to automatically incorporate feedback into agreement templates comprising:
receiving a plurality of executed agreements and contracting party characteristics corresponding to contracting parties for the executed agreements;
comparing the plurality of executed agreements to a plurality of stored agreement templates;
comparing the contracting party characteristics to stored entity characteristics assigned to the stored agreement templates; and
updating the stored agreement templates based on the comparison of the stored agreement templates and the contracting party characteristics.

12. The method of claim 10, further comprising analyzing external characteristics to determine trends and utilizing the determined trends to update the stored agreements.

13. The method of claim 12, wherein an external characteristic is information related to a change of law.

14. A method to generate an agreement comprising:
classifying a plurality of entity characteristics corresponding to a first party to be bound by the agreement;
based on the classification of the plurality of entity characteristics, generating one or more provisions for the agreement; and
outputting to a user device associated with the first party the one or more provisions for the agreement.

15. The method of claim 14, wherein generating one or more provisions for the agreement comprises selecting a first provision from a plurality of provisions based on the classification of the plurality of entity characteristics.

16. The method of claim 14, wherein the entity characteristics comprise user information regarding a user responsible for approving the agreement on behalf of the first party.

17. The method of claim 14, wherein the entity characteristics comprise one or more of: entity size, entity years of operation, product type, entity risk, number of customers, technology area, location, or personnel.

18. The method of claim 14, further comprising:
receiving from the user device associated with the first party, a proposed modification to the one or more provisions of the agreement; and
analyzing the proposed modification to determine that the proposed modification is acceptable; and
outputting to the user device associated with the first party, a modified agreement comprising the proposed modification.
